(19) United States
(12) Patent Application Publication
(10) Pub. No.: US 2005/0259113 A1
(43) Pub. Date: Nov. 24, 2005

(54) Information processing apparatus and display control method

(75) Inventors: Masaya Endo, Ome-shi (JP); Tsutomu Iwaki, Hanno-shi (JP); Shigeru Kizaki, Ome-shi (JP); Hiroaki Chiba, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/134,508

(22) Filed: May 23, 2005

(30) Foreign Application Priority Data
May 24, 2004 (JP) 2004-153717

(51) Int. Cl. G09G 5/02; G06F 15/80

(52) U.S. Cl. 345/604

(57) ABSTRACT

An information processing apparatus capable of displaying moving-picture image on a display device comprises a display controller which generates an image signal corresponding to a display image to be displayed on the display device, an image processing controller which processes the image signal generated by the display controller to enhance a quality of the display image, means for determining a type of the display device, and a controller configured to set an image quality enhancement parameter at the image processing controller according to the type of the display device determined by the determining means.

### CROSS-REFERENCE TO RELATED APPLICATIONS

This application is based upon and claims the benefit of priority from prior Japanese Patent Application No. 2004-153717, filed May 24, 2004, the entire contents of which are incorporated herein by reference.

### BACKGROUND OF THE INVENTION

1. Field of the Invention

The present invention relates to an information processing apparatus capable of displaying image data on a display device and a display control method for use in the apparatus.

2. Description of the Related Art

In recent years, there has been developed a personal computer comprising an audio video (AV) playback function which is similar to an AV device such as a digital versatile disc (DVD) player or a TV device.

For example, in Japanese Patent Application KOKAI Publication No. 2002-108486, there is disclosed a personal computer having a DVD drive unit and a TV tuner incorporated therein. In the computer disclosed in this document, a video signal obtained from the TV tuner is processed by an image controller, and then, the processed video signal is displayed on a display device directly connected to the image controller. The image controller processes text data or graphic data produced by the computer as an image signal of RGB such that the text data or the graphic data can be displayed on the display device. In the above document, a still-picture image signal and a moving-picture image signal are processed in the same way.

In the meantime, the moving-picture image data obtained by the DVD drive unit or TV tuner requires faithful color reproduction which is severer than the still-picture image data such as the text data or graphic data produced in the computer. The largest cause of a difference of color reproduction is a difference in characteristics of the display device. In the above document, there is not provided an image signal correction function for moving-picture image which carries out severe color correction for each display device.

### BRIEF SUMMARY OF THE INVENTION

It is an object of the present invention to provide an information processing apparatus capable of displaying an image with good color reproducibility regardless of the characteristics of a display device.

It is another object of the present invention to provide a display control method capable of displaying an image with good color reproducibility regardless of the characteristics of a display device.

According to an embodiment of the present invention, an information processing apparatus capable of displaying moving-picture image on a display device, the apparatus comprises a display controller which generates an image signal corresponding to a display image to be displayed on the display device, an image processing controller which processes the image signal generated by the display controller to enhance a quality of the display image, means for determining a type of the display device, and a controller configured to set an image quality enhancement parameter at the image processing controller according to the type of the display device determined by the determining means.

According to another embodiment of the present invention, an information processing apparatus comprises a display controller which generates an image signal corresponding to a display image to be displayed on a display device, a color correction circuit which carries out a color correction processing for the image signal generated by the display controller, means for determining a type of the display device, and a controller configured to set a color correction parameter at the color correction circuit according to the type of the display device determined by the determining means.

According to another embodiment of the present invention, a display control method for displaying moving-picture image on a display device of an information processing apparatus, wherein the information processing apparatus comprises a display controller which generates an image signal corresponding to a display image to be displayed on the display device, and an image processing controller which executes an image processing for enhancing an image quality of the display image, the display control method comprises steps of:

determining a type of the display device; and

setting an image quality enhancement parameter at the image processing controller according to the type of the display device determined by the determining step.

According to another embodiment of the present invention, a display control method for displaying image data on a display device of an information processing apparatus, wherein the information processing apparatus comprises a display controller which generates an image signal corresponding to a display image to be displayed on the display device, and a color correction circuit which carries out a color correction processing for the image signal generated by the display controller, the display control method comprises steps of:

determining a type of the display device; and

setting a color correction parameter at the color correction circuit according to the type of the display device determined by the determining step.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing an appearance of a personal computer according to an embodiment of the present invention;

FIG. 2 is a block diagram showing a system configuration of the personal computer shown in FIG. 1;

FIG. 3 is a block diagram showing a configuration of a high quality video engine provided in the personal computer shown in FIG. 1;

FIG. 4 is a flow chart showing procedures for display control processing executed in the personal computer shown in FIG. 1; and

FIG. 5 is a view showing an example of an interface for setting a correction parameter at the high quality video engine provided in the personal computer shown in FIG. 1.

### DETAILED DESCRIPTION OF THE INVENTION

An embodiment of an information processing apparatus according to the present invention will now be described with reference to the accompanying drawings.

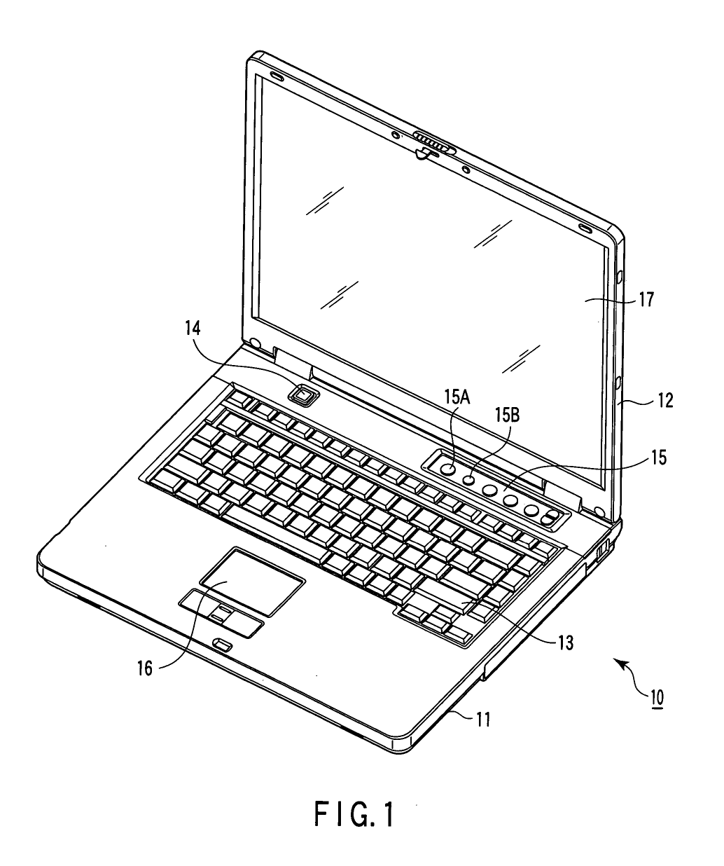

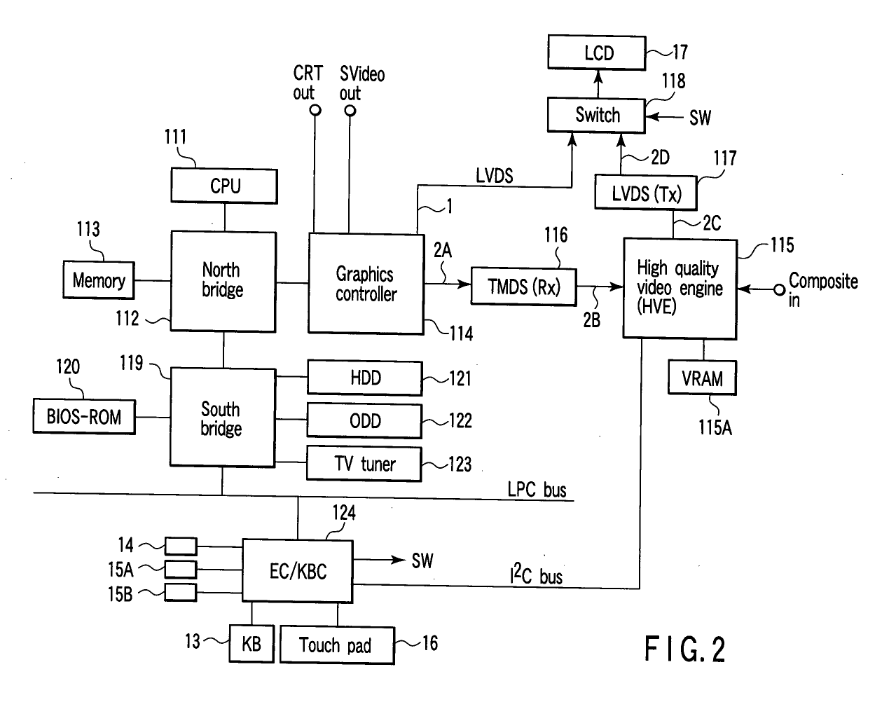

Referring now to FIGS. 1 and 2, a description will be given with respect to a configuration of an information processing apparatus according to an embodiment of the present invention. This information processing apparatus, for example, is embodied as a notebook type personal computer 10.

FIG. 1 is a perspective view showing a display device of the notebook type personal computer 10 when the display device is opened. The personal computer 10 comprises a main body 11 and a display device 12. The display device 12 incorporates a display unit comprising a liquid crystal display (LCD) 17. A display screen of the LCD 17 is located at a substantial center of the display device 12. The display screen of the LCD 17 has an aspect ratio of 16:9 so as to cope with a high definition (HD) television picture.

The display device 12 is turnably mounted between an open state and a closed state with respect to the main body 11. The main body 11 has a thin box shaped casing. On the upper surface of the casing, there are provided a keyboard 13, a power button 14 for turning ON/OFF the power of the computer 10, an input operation panel 15, a touch pad 16 and the like.

The input operation panel 15 is provided as an input device for inputting an event which corresponds to a pressed button. The operation panel 15 comprises a plurality of buttons for starting up a plurality of functions, respectively. These buttons include a TV startup button 15A and a DVD/CD startup button 15B. The TV startup button 15A is a button for displaying TV broadcast program data. When a user presses the TV startup button, an application program for displaying the TV broadcast program data is automatically started up. The DVD/CD startup button 15B is a button for reproducing video contents recorded in a DVD or CD. When the user presses the DVD/CD startup button 15B, an application program for reproducing the video contents is automatically started up.

The personal computer 10 of this embodiment has a function for automatically enhancing an image quality of moving-picture image data during reproduction of the moving-picture image data in order to display the moving-picture image data such as TV broadcast program data or video contents on the LCD 17 with a high image quality.

Now, a system configuration of the computer 10 will be described with reference to FIG. 2.

The computer 10, as shown in FIG. 2, comprises a CPU 111, a north bridge 112, a main memory 113, a graphics controller 114, a high quality video engine (HVE) 115, a TMDS (Rx) processor 116, an LVDS (Tx) processor 117, a switch 118, a south bridge 119, a BIOS-ROM 120, a hard disk drive (HDD) 121, an optical disk drive (ODD) 122, a TV tuner 123, an embedded controller/keyboard controller IC (EC/KBC) 124, and the like.

The CPU 111 is a processor for controlling an operation of the computer 10, and executes an operating system (OS) and a variety of application programs loaded from the HDD 121 into the main memory 113. The OS has a window system for displaying a plurality of windows on the display screen.

Moving-picture image data (such as TV broadcast program data received by the TV tuner 123 or video contents stored in a storage medium such as a DVD) is generally displayed in a window which corresponds to a video playback application program for reproducing the moving-picture image data. In this case, for example, a window corresponding to the video playback application program is allocated on a desktop screen, and the moving-picture image data is displayed in the window (window mode). In addition, the computer 10 can display the moving-picture image data in a full screen mode on the display screen of the LCD 17. In this full screen mode, only the moving-picture image data is displayed in a substantially whole area on the display screen. In this case, the desktop screen and a window corresponding to an application program other than the video playback application program are not displayed. In addition, a menu bar or the like in the window corresponding to the video playback application program is not displayed, and only the moving-picture image data is displayed in a substantially whole area on the display screen.

The CPU 111 also executes a system basic input output system (BIOS) stored in the BIOS-ROM 120. The system BIOS is provided as a program for hardware control.

The north bridge 112 is provided as a bridge device for making connection between a local bus of the CPU 111 and the south bridge 119. The north bridge 112 incorporates a memory controller for accessing and controlling the main memory 113. Also, the north bridge 112 has a function for executing communication with the graphics controller 114 via an accelerated graphics port (AGP) bus or the like.

The graphics controller 114 is provided as a display controller for controlling the LCD 17 used as a display monitor of the computer 10. The graphics controller 114 has a video memory (VRAM), and generates an image signal for forming a display image to be displayed on the LCD 17 from among the display data written in the video memory by means of an OS/application program. The display image to be displayed on the LCD 17 generally comprises an image on the desktop screen and an image of a respective one of the windows allocated on the desktop screen. In the case where the moving-picture image data is displayed in the full screen mode, however, the display image to be displayed on the LCD 17 comprises only the image of the moving-picture image data. Therefore, in the case where the moving-picture image data is displayed in the full screen mode, an image signal for forming only the display image of the moving-picture image data is output from the graphics controller 114.

The image signals generated by the graphic controller 114 are output to a line 1 and a line 2A, respectively. The image signal output to the line 1 comprises, for example, an 18-bit signal conforming to a low voltage differential signaling (LVDS) format. The image signal output to the line 2A comprises, for example, a 24-bit signal conforming to a transition minimized differential signaling (TMDS) format. The graphic controller 114 also has an interface for outputting an analog image signal to an external cathode ray tube (CRT) and an interface for externally outputting an analog image signal via an S video terminal.

The TMDS (Rx) processor 116 converts the 24-bit signal conforming to the TMDS format, the signal being sent from the graphic controller 114 via the line 2A, into a 24-bit RGB digital signal. Then, the processor 116 sends the 24-bit RGB digital signal to the high quality video engine (HVE) 115 via a line 2B.

The high quality video engine (HVE) 115 is provided as an image processing controller which executes picture processing for enhancing a quality of the image signal generated by the graphic controller 114 (hereinafter, referred to as image quality correction processing). The high quality video engine (HVE) 115 has a video memory (VRAM) 115A. The image quality correction processing is executed on the video memory (VRAM) 115A. This image quality correction processing is provided as picture processing used for a moving-picture image only for enhancing a moving-picture image. This processing is executed to display a smooth and high quality moving-picture image on the LCD 17. In the image quality correction processing, a variety of processings such as color correction (gamma correction, white balance control, brightness control, or contrast control), sharpness control, edge enhancement, and improvement of response speed are carried out in order to improve an image quality of a moving-picture image, for example.

In addition, the high quality video engine (HVE) 115 can apply image quality correction processing to an image signal input from an external video device via a composite input terminal.

The image signal whose image quality has been enhanced by the high quality video engine (HVE) 115 is sent to the LVDS (Tx) processor 117 via a line 2C. The LVDS (Tx) processor 117 converts the RGB digital signal whose image quality has been enhanced, the signal being output from the high quality video engine (HVE) 115, into a signal conforming to the LVDS format. Then, the processor 117 outputs the signal conforming to the LVDS format onto a line 2D. In the case where an external LCD panel is used, a connection terminal is connected to an output of the LVDS (Tx) processor 117.

Further, the high quality video engine (HVE) 115 has a scaling function for changing resolution of an image signal and an aspect ratio. Scaling of the image signal is executed after the image quality correction processing of that image signal has been executed. A moving-picture image can be displayed with a higher quality by carrying out image quality correction processing for raw data before scaled, followed by scaling the image signal obtained after the image quality correction processing rather than carrying out image quality correction for the scaled image signal.

The switch 118 functions as a selector for selectively outputting to the LCD 118 one of the image signal generated by the graphic controller 114 and the image signal whose image quality has been corrected by the high quality video engine (HVE) 115. The switch 118 has a first input terminal connected to the line 1, a second input terminal connected to the line 2D, and an output terminal connected to the LCD 17. The switch 118 selects one of the first input terminal and the second input terminal in response to a switch control signal SW supplied from the embedded controller/keyboard controller IC (EC/KBC) 124, and connects the selected input terminal to the output terminal. By an operation of the switch 118, the following two display control modes can be used in the present embodiment.

(1) Normal Mode:

In a normal mode, the image signal from the graphics controller 114 is sent out to the LCD 17 without passing through the high quality video engine (HVE) 115. This normal mode is used in the case where a still image is included in the display image displayed on the LCD 17.

(2) High Quality Mode:

In a high quality mode, the image signal from the graphics controller 114 is sent out to the LCD 17 via the high quality video engine (HVE) 115. This high quality mode is used in the case where a still image is not included in the display image displayed on the LCD 17, namely, in the case where the moving-picture image data is displayed in the full screen mode.

However, the specific example of changeover of the switch 118 described above is provided as a mere example, and the high quality mode may always be set regardless of the moving-picture image and/or still image.

The south bridge 119 controls each of the devices on a low pin count (LPC) bus. The south bridge 119 also incorporates an integrated drive electronics (IDE) controller for controlling the HDD 121 and the ODD 122. Further, the south bridge 119 has a function for controlling the TV tuner 123 and a function for accessing and controlling the BIOS-ROM 120.

The ODD 123 is provided as a drive unit for driving a storage medium such as a DVD or a CD having video contents stored therein. The TV tuner 123 is provided as a receiver unit for receiving broadcast program data such as a TV broadcast program.

The embedded controller/keyboard controller IC (EC/KBC) 124 is provided as an one-chip microcomputer having integrated an embedded controller for power management and a keyboard controller for controlling the keyboard (KB) 13 and the touch pad 16. The embedded controller/keyboard controller IC (EC/KBC) 124 has a function for turning ON/OFF the power of the computer 10 in response to the user's operation of the power button 14.

Further, the embedded controller/keyboard controller IS (EC/KBC) 124 has a function for making communication with the high quality video engine (HVE) 115 via an I²C bus, and a function for supplying the above-described switch control signal SW to the switch 118.

The LCD 17 is also connected to the south bridge 119 via an extension interface (not shown). This is because LCD type (such as manufacturer type, product model, or lot number) information is notified from the LCD 17 to the system BIOS. As the extension interface, an interface enabling information transmission from the display side called a display data channel (DDC) to a host is available. This interface is used to determine a display format name from the personal computer or inquire a synchronization enable frequency. In the embodiment, by utilizing this interface, LCD type information (including manufacture type, product model, lot number and the like) can be determined instead of a format name.

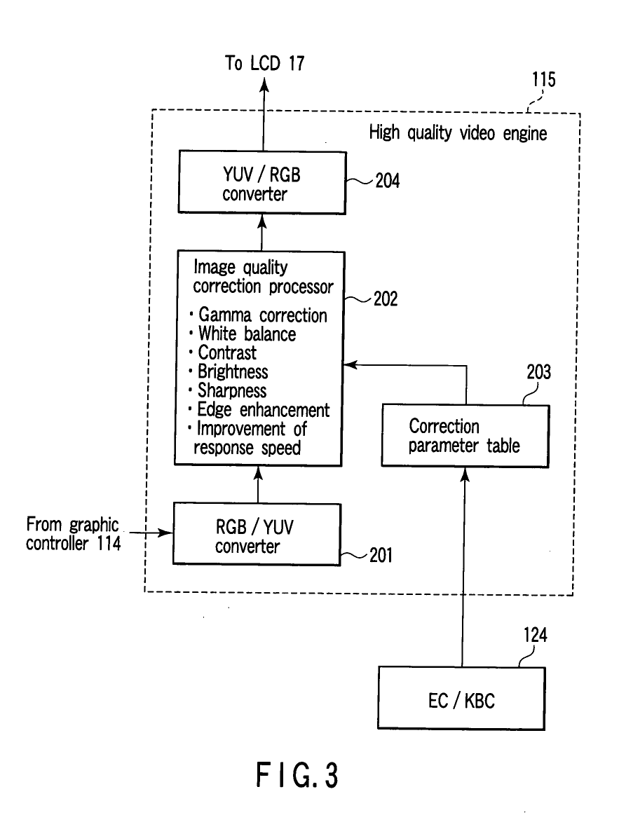

Now, an example of a configuration of the high quality video engine (HVE) 115 will be described with reference to FIG. 3.

The high quality video engine (HVE) 115, as illustrated, comprises an RGB/YUV converter 201, an image quality correction processor 202, a correction parameter table 203, a YUV/RGB converter 204, and the like.

The RGB/YUV converter 201 converts an image signal transmitted from the graphics controller 114 via the TMDS (Rx) processor 116 from a 24-bit RGB digital signal to a 24-bit YUV signal. In response to this YUV signal, the image quality correction processor 202 applies computational processing for image quality correction of that signal (color correction (gamma correction, white balance control, brightness control, and contrast control), sharpness control, edge enhancement, and improvement of response speed). These correction/control operations each use different correction values/control values (hereinafter, referred to as correction parameters) according to type of the LCD 17. The correction parameters are stored for each type of the LCD 17 in the correction parameter table (ROM) 203. The type of the LCD 17 includes a product model and a product lot number as well as a manufacturer type. This is because, although color reproducibility of the display mainly depends on the characteristics of a color filter of the LCD panel, if a lot is different from another in a product of the same manufacturer and the same model, a color filter used may be different from another. In the computer 10 shown in FIG. 1, although the display device 12 has been described to be an integrated type, an external display device 12 may be connected separately. Even in the case of the integrated type, it is preferable that the correction parameters are stored for all the types of the LCD 17 which will be or may be used as the display device 12 of the computer 10, in preparation to replace the LCD 17 after shipment. All the correction parameters for correction/control may not be changed for each type of the LCD 17. Only the correction parameters (gamma correction value, white balance control value, brightness control value, and contrast control value) relating to color correction which deeply depends on the type of the LCD 17 may be stored in the correction parameter table (ROM) 203. In this case, for sharpness control, edge enhancement, or improvement of response speed, predetermined correction parameters are used regardless of the type of the LCD 17.

Now, the color correction included in image quality correction processing operations will be described below.

A response characteristic between a numeric value indicating a color and intensity of a color to be actually input or output is indicated as a gamma value. Input or output devices such as an image scanner, a display device and a printer have their own gamma values, respectively. Controlling this gamma value in order to carry out color correction of the whole system is referred to as gamma correction. The gamma value is a parameter indicating the degree of non-linearity for the intensity of an output signal in response to an input signal. In the display device, it is ideal that an output intensity (output brightness in the case of the display device) linearly changes with a change of a value of an input signal. However, in an actual display device, this linear change does not always occur. When a value I is obtained by normalizing the intensity of an input signal in the range of 0 to 1, and a value O is obtained by normalizing the intensity of an output signal in the same range, a relationship between them can be approximated by a formula of O=Iγ. The value of γ is referred to as a gamma value. The correction parameter table 203 stores the gamma values for each type of the LCD 17.

The contrast is controlled by changing a change rate of an output intensity with a change of an input signal. That is, in the case where a graph is plotted while an input signal is defined on a horizontal axis and the brightness of an image to be displayed is defined on a vertical axis, the degree of gradient in the graph expresses the strength of contrast. When the contrast is enhanced, a difference in brightness between a bright portion and a dark portion in the screen is made clear. In particular, characters or the like can be easily read. If the contrast is enhanced excessively, however, the range of brightness of the dark portion and bright portion which can be expressed on the display is exceeded, and an input signal cannot be precisely reflected. This phenomenon is referred to as a “black level saturation” or “flashing highlights”. That is, it is desired that the contrast is enhanced in the range such that such “black collapse” or “white collapse” does not occur.

The brightness is controlled by uniformly changing the brightness of the whole screen regardless of an input signal. In the case where a graph is plotted while an input signal is defined on a horizontal axis and the brightness of an image to be displayed is defined on a vertical axis, a change in graph height expresses the brightness. Brightness control is effective in the case where visibility is controlled according to the brightness of an environment in which the display device is used. However, if the range of the bright and dark portions expressed by the display has been exceeded as is the case with contrast control, a phenomenon such as “black collapse” or “white collapse” occurs. Thus, it is desired that the brightness is enhanced in the range such that such “black collapse” or “white collapse” does not occur.

A function for correcting coloring of an object according to a state of a light source is a white balance control function. For example, when plane paper is placed under sunset, such paper should be essentially seen to be slightly yellowed. However, a human eye is prone to recognize it as white. Therefore, the white balance-control is made to ensure that the state of a specific light source is simulated, thereby controlling the whole color balance such that a white portion can be whitely seen.

The YUV/RGB converter 204 converts an image signal whose image quality has been corrected from a 24-bit YUV signal into an 18-bit RGB signal. The RGB signal is sent to the LVDS (Tx) processor 117 via the line 2C.

Although not shown in FIG. 3, the high quality video engine (HVE) 115 also has a scaling processing function. This function is provided for scaling the YUV signal whose image quality has been corrected in accordance with scaling parameter information set in a scaling register. Scaling is a processing function for changing size (resolution) of moving-picture image data. By this scaling processing, the size (resolution) of the moving-picture image data is changed to a size suitable to the size (panel resolution) of the display screen of the LCD 17. The scaling parameter information, for example, includes resolution of the moving-picture image data, an aspect ratio of the moving-picture image data, and panel resolution of the LCD 17.

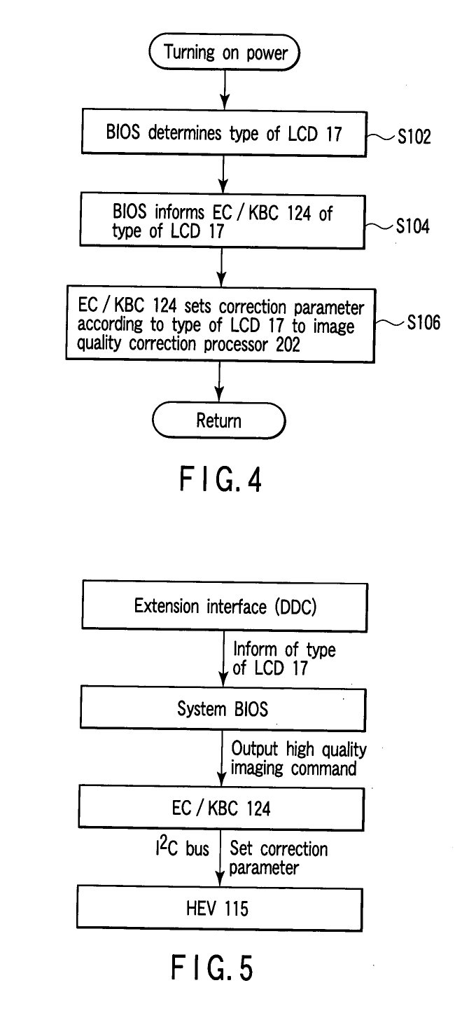

Referring now to the flow chart of FIG. 4, a description will be given with respect to a display control processing operation executed by the computer 10.

When power is turned ON, the system BIOS determines the type of the LCD 17 connected to the south bridge 119 via a DDC interface (step S102). As described above, it is known that a manufacturer of a color filter may different depending on a lot even if the display device of the same manufacturer and the same model is used; and that color reproducibility is different depending on the characteristics of the color filter rather than each display device. The type of the LCD 17 includes a manufacture type, a product model, a lot number and the like.

The system BIOS notifies the EC/KBC 124 of an image quality enhancement command which includes the type of the LCD 17 (step S104). In step S106, the EC/KBC 124 reads out the correction parameter according to the type of the LCD 17 from the correction parameter table 203, and sets the read-out parameter at the image quality correction processor 202. In this manner, the image quality correction processor 202 can carry out color correction processing in response to the correction parameter according to the type of the connected LCD 17, enabling faithful color reproduction.

As described in FIG. 1, the LCD 17 is not externally provided, and is of integrated type. Thus, only one correction will suffice at the time of shipment of a personal computer. However, even in the case of the integrated type, the LCD 17 may be replaced with the replacement LCD if a failure occurs. In addition, it is preferable that compatibility with an external LCD is achievable. Therefore, when power is turned ON, the BIOS is designed to carry out the correction value setting processing shown in FIG. 4. In the case where the display is of integrated type, however, only one correction will suffice at the time of product manufacturing, and there is no need for making such correction every time when power is turned ON.

FIG. 5 shows an example of an interface for setting a correction parameter at the high quality video engine (HVE) 115.

The type of the LCD 17 is notified to the system BIOS via the extension interface such as a DDC. The EC/KBC 124 reads out the correction parameter according to the type of the LCD 17 from the correction parameter table 203 in accordance with the image quality enhancement command from the system BIOS, and sets the read-out parameter at the high quality video engine (HVE) 115. The high quality video engine (HVE) 115 carries out image quality correction processing according to the set correction value or control value.

As has been described above, according to the present embodiment, when power is turned ON, the BIOS determines the type of the LCD 17. The BIOS notifies the EC/KBC 124 of the image quality enhancement command which includes the type of the LCD 17. The EC/KBC 124 reads out the correction parameters (such as a gamma correction value, a while balance control value, a contrast control value, and a brightness control value) according to the type of the LCD 17 from the correction parameter table 203, and sets the read-out parameters at the image quality correction processor 202. In this manner, the image quality correction processing according to the type of the LCD 17 is carried out for the image data output from the graphics controller 114 in the high quality video engine 115, thus making it possible to improve color reproducibility of image data. The image quality correction processor 202 can carry out color correction processing in response to the correction parameter according to the type of the corrected LCD 17, enabling faithful color reproduction.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, although the embodiment has described an example in which, in the case where a still-picture image is included in the display image displayed on the LCD 17, the image signal from the graphics controller 114 is sent out directly to the LCD 17 without passing through the high quality video engine 115 (in the case where a still-picture image is not color-corrected.), color correction may be carried out for a still-picture image as well as a moving-picture image by means of the high quality video engine 115. Further, in the embodiment, although the correction parameters have been set for all the processings of the high quality video engine 115 according to the type of the LCD 17, only the correction parameters relating to color correction may be set according to the type of the LCD 17. In this case, the correction parameters for the remaining processing must be constant regardless of the type of the LCD 17. In addition, although the high quality imaging processing has been carried out for the YUV image signal, this processing may be carried out for the RGB image signal.

1. An information processing apparatus capable of displaying moving-picture image on a display device, the apparatus comprising:
a display controller which generates an image signal corresponding to a display image to be displayed on the display device;
an image processing controller which, based on an image quality enhancement parameter, processes the image signal generated by the display controller to enhance a quality of the display image;
means for determining a type of the display device; and
a controller configured to set an image quality enhancement parameter at the image processing controller according to the type of the display device determined by the determining means.

2. An information processing apparatus according to claim 1, wherein the image processing controller applies to the image signal any of gamma correction, white balance control, brightness control, contrast control, sharpness control, edge enhancement, and improvement of a response speed.

3. An information processing apparatus according to claim 1, wherein
the display controller outputs an RGB image signal, and
the image processing controller converts the RGB image signal output from the display controller into a YUV image signal, applies an image quality enhancement processing to the YUV image signal, converts the YUV image signal obtained after the image quality enhancement processing into an RGB image signal, and outputs a converted RGB image signal.

4. An information processing apparatus according to claim 1, wherein the display device includes an external display device.

5. An information processing apparatus comprising:
a display controller which generates an image signal corresponding to a display image to be displayed on a display device;
a color correction circuit which, based on a color correction parameter, carries out a color correction processing for the image signal generated by the display controller;
means for determining a type of the display device; and
a controller configured to set a color correction parameter at the color correction circuit according to the type of the display device determined by the determining means.

6. An information processing apparatus according to claim 5, wherein the color correction circuit applies to the image signal any of gamma correction, white balance control, brightness control, and contrast control.

7. A display control method for displaying moving-picture image on a display device of an information processing apparatus, wherein the information processing apparatus comprises a display controller which generates an image signal corresponding to a display image to be displayed on the display device, an image processing controller which, based on an image quality enhancement parameter, and executes an image processing for enhancing an image quality of the display image, the display control method comprising steps of:
determining a type of the display device; and
setting an image quality enhancement parameter at the image processing controller according to the type of the display device determined by the determining step.

8. A display control method according to claim 7, wherein the image quality enhancement parameter comprises a correction value or a control value of any of gamma correction, white balance control, brightness control, contrast control, sharpness control, edge enhancement, and improvement of a response speed.

9. A display control method for displaying image data on a display device of an information processing apparatus, wherein the information processing apparatus comprises a display controller which generates an image signal corresponding to a display image to be displayed on the display device, and a color correction circuit, based on a color correction parameter, which carries out a color correction processing for the image signal generated by the display controller, the display control method comprising steps of:
determining a type of the display device; and
setting a color correction parameter at the color correction circuit according to the type of the display device determined by the determining step.

10. A display control method according to claim 9, wherein the color correction parameter comprises a correction value or a control value of any of gamma correction, white balance control, brightness control, and contrast control.
